(19) United States
(12) Patent Application Publication
(10) Pub. No.: US 2025/0119792 A1
(43) Pub. Date: Apr. 10, 2025

(54) BASE STATION SLEEPING STRATEGY IN HETEROGENOUS CELLULAR NETWORKS BASED ON USER TRAFFIC PREDICTION

(71) Applicant: CITY UNIVERSITY OF HONG KONG, Kowloon (HK)

(72) Inventors: Xinyu WANG, Hong Kong (HK); Bingchen LYU, Shanghai (CN); Chao GUO, Hong Kong (HK); Jiahe XU, Hong Kong (HK); Moshe ZUKERMAN, Hong Kong (HK)

(73) Assignee: CITY UNIVERSITY OF HONG KONG, Kowloon (HK)

(21) Appl. No.: 18/738,730

(22) Filed: Jun. 10, 2024

Related U.S. Application Data
(60) Provisional application No. 63/589,081, filed on Oct. 10, 2023.

(51) Int. Cl. H04W 28/086; H04W 24/02; H04W 28/08

(52) U.S. Cl. CPC H04W 28/0861; H04W 24/02; H04W 28/0967

(57) ABSTRACT

A BS sleeping strategy for a two-tier HeCN that consists of MaBS and MiBS. The approach involves strategically consolidating workloads distributed across the network onto fewer BSs. At the heart of the strategy is a Bidirectional Long Short-Term Memory (BLSTM) neural network, which predicts future traffic for each user. The predicted traffic data informs the proposed BS sleeping strategy, which shifts user connections from under-utilized MiBSs to other BSs, subsequently powering down the idle MiBSs, while MaBSs remain always on. This strategy is executed with utmost consideration for maintaining service quality, ensuring that the switch does not degrade each user's Signal-to-Interference-plus-Noise Ratio thresholds or traffic demand rate.

### CROSS-REFERENCE TO RELATED APPLICATIONS

The present application claims priority to U.S. Provisional Patent Application No. 63/589,081 filed on Oct. 10, 2023, which application is incorporated herein by reference in its entirety.

### FIELD OF INVENTION

This invention relates to the field of mobile cellular networks, and in particular to prediction methodologies for traffic of mobile cellular networks.

### BACKGROUND OF INVENTION

Mobile internet services, such as mobile payments, online maps, and real-time videos, have become integral to people's daily lives. With the widespread use of smartphones, tablets, wearable devices, and Internet of Things (IoT) applications, the number of devices connected to the network has significantly increased. In early 2022, the number of IoT devices reached 14.4 billion, an increase of 18% compared to 2021 [1]. This growth in connected devices has led to a substantial increase in data traffic. By the end of 2021, the global mobile data traffic had reached around 84 EB per month, and it is estimated to increase by about 4.2 times, reaching 368 EB per month in 2027 [2].

To keep up with this explosive growth in data traffic, the construction and deployment of fourth-generation and fifth-generation wireless networks have been promoted and popularized, increasing the number of Base Stations (BSs) and the capacity and coverage of mobile cellular networks. However, as Information and Communications Technologies (ICTs) account for 1.8%-2.8% of global greenhouse gas emissions [3], and BSs consume more than 80% of the energy in mobile cellular networks [4], energy efficiency (EE) has become a crucial concern. Optimal BS switching on/off and BS sleeping strategies [5], [6] can significantly improve the EE of mobile cellular networks, reducing greenhouse gas emissions and leading to considerable cost savings. Therefore, such strategies and solutions have become critical to the design of future mobile cellular networks.

However, the unprecedented number of mobile device connections in the network and the diversification of data service types have rendered traditional Homogeneous Cellular Networks (HoCNs) inadequate to meet the complex requirements of future networks. HoCNs consist of BSs with similar working modes and transmit patterns [7]. To address this issue, Heterogeneous Cellular Networks (HeCNs) have been introduced, which can achieve flexible and low-cost deployment by adding Micro Base Stations (MiBSs), such as pico and femto BSs, with different working modes and transmit patterns within the coverage of Macro Base Stations (MaBSs). This approach increases data transmission rates and complements the coverage area, as shown in FIG. 1. The MiBSs have different carrier frequencies than MaBSs and do not cause interference to MaBSs in the same coverage area.

In HeCNs, MiBSs can be shut down or switched to sleep mode at appropriate times, providing a significant opportunity to reduce the excessive energy consumption of BSs. This attribute makes HeCNs more amenable to BS sleeping than the earlier, more rigid HoCNs because, in a HeCN, a user of a shutdown MiBS can connect to a MaBS that covers their location. In contrast, in a HoCN, if a BS shuts down, its users may not obtain the required Quality of Service (Qos) by connecting to active, far-away BSs. The flexibility of HeCNs enables efficient network management and better utilization of network resources, making them a promising solution for future mobile networks.

Researchers have focused on analyzing and predicting mobile cellular network data traffic to find the best BS sleeping schedule. Studies such as [8], [9] have found that traffic in mobile cellular networks exhibits strong self-similarity and follows general regularity in spatiotemporal distribution. This predictability of mobile cellular network traffic has made it a topic of exploration for researchers. Additionally, there is a significant difference in the traffic pattern between day and night for every working day [8], [10]. Therefore, analyzing the historical traffic data for a specific period in the same area can effectively predict the network traffic demand in the area for a certain period in the future based on the spatiotemporal distribution of users' mobile data traffic.

Prediction methodologies for the traffic of mobile cellular networks that enable BS sleeping scheduling in different periods have been studied under specific scenarios. In [11], [12], [13], there are proposed BS sleeping strategies to reduce energy consumption based on predicted traffic, but they were all for HoCNs. For example, Lin et al. [14] predicted data traffic in HeCNs and proposed BS sleeping strategies based on the predicted traffic without considering the differences between the traffic demands of different users in the network and the effect of the locations of the different BSs on the performance of sleeping strategies. Donevski et al. [15] proposed methods to find the optimal BS sleeping times in HeCNs based on traffic prediction using neural networks but did not specify user reallocation. Specifically, for the association between users and BSs, since the transmission power of MaBSs in HeCNs is much greater than that of MiBSs, users will prefer to choose MaBSs that can provide a better QoS without particular intervention, causing MiBSs not to be fully utilized or even empty-loaded. Therefore, a BS sleeping strategy must consider the effect of different BS deployment methods on the performance of sleeping strategies and control user choices to achieve sufficient utilization of MiBSs in HeCNs during the sleeping periods. These essential enhancements to the BS sleeping strategy will lead to load balancing among BSs and energy saving.

### REFERENCES

The following references are referred to throughout this specification, as indicated by the numbered brackets. The disclosures of each of these references are hereby incorporated by reference herein in their entireties for all purposes.
[1] M. Hasan. “State of IoT 2022: Number of connected IoT devices growing 18% to 14.4 billion globally.” IoT Analytics. May 2022. Accessed: Mar. 10, 2023. [Online]. Available: https://iot-analytics.com/numberconnected-iot-devices/
[2] R. Möller. “Ericsson mobility report.” Ericsson. Rep., June 2022. Accessed: Mar. 10, 2023. [Online]. Available: https://www.ericsson.com/49d3a0/assets/local/reports-papers/mobility-report/documents/2022/ericsson-mobility-report-june-2022.pdf
[3] C. Freitag, M. Berners-Lee, K. Widdicks, B. Knowles, G. S. Blair, and A. Friday, “The real climate and transformative impact of ICT: A critique of estimates, trends, and regulations,” Patterns, vol. 2, no. 9, 2021, Art. no. 100340.
[4] T. Yang, F. Heliot, and C. H. Foh, “A survey of green scheduling schemes for homogeneous and heterogeneous cellular networks,” IEEE Commun. Mag., vol. 53, no. 11, pp. 175-181, November 2015.
[5] J. Wu, S. Zhou, and Z. Niu, “Traffic-aware base station sleeping control and power matching for energy-delay tradeoffs in green cellular networks,” IEEE Trans. Wireless Commun., vol. 12, no. 8, pp. 4196-429 August 2013.
[6] Z. Niu, X. Guo, S. Zhou, and P. R. Kumar, “Characterizing energy-delay tradeoff in hyper-cellular networks with base station sleeping control,” IEEE J. Sel. Areas Commun., vol. 33, no. 4, pp. 641-650, April 2015.
[7] S. Salim, C. H. Oey, and S. Moh, “Are heterogeneous cellular networks superior to homogeneous ones?” in Proc. 9th IFIP Int. Conf. Netw. Parallel Comput. (NPC), 2012, pp. 61-68.
[8] U. Paul, A. P. Subramanian, M. M. Buddhikot, and S. R. Das, “Understanding traffic dynamics in cellular data networks,” in Proc. 30^{th} IEEE Conf. Comput. Commun. (INFOCOM), 2011, pp. 882-890.
[9] E. M. Rezende Oliveira, A. C. Viana, K. P. Naveen, and C. Sarraute, “Measurement-driven mobile data traffic modeling in a large metropolitan area,” in Proc. 13th IEEE Int. Conf. Pervasive Comput. Commun. (PerCom), 2015, pp. 230-235.
[10] Y. Wang, M. Faloutsos, and H. Zang, “On the usage patterns of multimodal communication: Countries and evolution,” in Proc. 32^{nd} IEEE Conf. Comput. Commun. (INFOCOM), 2013, pp. 3135-3140.
[11] Q. Wu, X. Chen, Z. Zhou, L. Chen, and J. Zhang, “Deep reinforcement learning with spatio-temporal traffic forecasting for data-driven base station sleep control,” IEEE/ACM Trans. Netw., vol. 29, no. 2, pp. 935-948, April 2021.
[12] G. Jang, N. Kim, T. Ha, C. Lee, and S. Cho, “Base station switching and sleep mode optimization with LSTM-based user prediction,” IEEE Access, vol. 8, pp. 222711-222723, 2020.
[13] R. Shinkuma, N. Kishi, K. Ota, M. Dong, T. Sato, and E. Oki, “Smarter base station sleeping for greener cellular networks,” IEEE Netw., vol. 35, no. 6, pp. 98-103, November/December 2021.
[14] J. Lin, Y. Chen, H. Zheng, M. Ding, P. Cheng, and L. Hanzo, “A data-driven base station sleeping strategy based on traffic prediction,” IEEE Trans. Netw. Sci. Eng., early access, Sep. 2, 2021, doi: 10.1109/TNSE.2021.3109614.
[15] I. Donevski, G. Vallero, and M. A. Marsan, “Neural networks for cellular base station switching,” in Proc. 38th IEEE Conf. Comput. Commun. Workshops (INFOCOM WKSHPS), 2019, pp. 738-743.
[16] C. Liu, Y. Wan, L. Tian, Y. Zhou, and J. Shi, “Base station sleeping control with energy-stability tradeoff in centralized radio access networks,” in Proc. 34th IEEE Glob. Commun. Conf. (GLOBECOM), 2015, pp. 1-6.
[17] M. Wildemeersch, T. Q. Quek, C. H. Slump, and A. Rabbachin, “Cognitive small cell networks: Energy efficiency and trade-offs,” IEEE Trans. Commun., vol. 61, no. 9, pp. 4016-4029, September 2013.
[18] A. Ghosh et al., “Heterogeneous cellular networks: From theory to practice,” IEEE Commun. Mag., vol. 50, no. 6, pp. 54-64, June 2012.
[19] H. ElSawy, E. Hossain, and M. Haenggi, “Stochastic geometry for modeling, analysis, and design of multi-tier and cognitive cellular wireless networks: A survey,” IEEE Commun. Surveys Tuts., vol. 15, no. 3, pp. 996-1019, 3rd Quart., 2013.
[20] W. Guo, S. Wang, X. Chu, J. Zhang, J. Chen, and H. Song, “Automated small-cell deployment for heterogeneous cellular networks,” IEEE Commun. Mag., vol. 51, no. 5, pp. 46-53, May 2013.
[21] H. T. Cheng, A. Callard, G. Senarath, H. Zhang, and P. Zhu, “Step-wise optimal low power node deployment in LTE heterogeneous networks,” in Proc. 76th IEEE Veh. Technol. Conf. (VTC Fall), 2012, pp. 1-4.
[22] B. Yang, G. Mao, X. Ge, M. Ding, and X. Yang, “On the energy-efficient deployment for ultra-dense heterogeneous networks with NLOS and LoS transmissions,” IEEE Trans. Green Commun. Netw., vol. 2, no. 2, pp. 369-384, June 2018.
[23] Z. Mlika, E. Driouch, and W. Ajib, “Energy-efficient base station operation and association in HetNets: Complexity and algorithms,” IEEE Trans. Wireless Commun., vol. 17, no. 4, pp. 2690-272 April 2018.
[24] S. Ak, H. Inaltekin, and H. V. Poor, “A tractable framework for the analysis of dense heterogeneous cellular networks,” IEEE Trans. Commun., vol. 66, no. 7, pp. 3151-3171 July 2018.
[25] C. S. Chen, V. M. Nguyen, and L. Thomas, “On small cell network deployment: A comparative study of random and grid topologies,” in Proc. 76th IEEE Veh. Technol. Conf. (VTC Fall), 2012, pp. 1-5.
[26] C. Coletti, P. Mogensen, and R. Irmer, “Deployment of LTE in-band relay and micro base stations in a realistic metropolitan scenario,” in Proc. 74th IEEE Veh. Technol. Conf. (VTC Fall), 2011, pp. 1-5.
[27] C. Coletti et al., “Heterogeneous deployment to meet traffic demand in a realistic LTE urban scenario,” in Proc. 76th IEEE Veh. Technol. Conf. (VTC Fall), 2012, pp. 1-5.
[28] L. Hu, I. Z. Kovács, P. Mogensen, O. Klein, and W. Stormer, “Optimal new site deployment algorithm for heterogeneous cellular networks,” in Proc. 74th IEEE Veh. Technol. Conf. (VTC Fall), 2011, pp. 1-5.
[29] A. Cao, Y. Qiao, K. Sun, H. Zhang, and J. Yang, “Network traffic analysis and prediction of hotspot in cellular network,” in Proc. 6th IEEE Int. Conf. Netw. Infrastruct. Digit. Content (IC-NIDC), 2018, pp. 452-456.
[30] F. Xu et al., “Big data driven mobile traffic understanding and forecasting: A time series approach,” IEEE Trans. Services Comput., vol. 9, no. 5, pp. 796-805, September/October 2016.
[31] K. Sultan, H. Ali, and Z. Zhang, “Call detail records driven anomaly detection and traffic prediction in mobile cellular networks,” IEEE Access, vol. 6, pp. 41728-41737, 2018.
[32] M. Zhang, H. Fu, Y. Li, and S. Chen, “Understanding urban dynamics from massive mobile traffic data,” IEEE Trans. Big Data, vol. 5, no. 2, pp. 266-278, June 2019.
[33] M. Xu, Q. Wang, and Q. Lin, “Hybrid holiday traffic predictions in cellular networks,” in Proc. 16th IEEE/IFIP Netw. Oper. Manage. Symp. (NOMS), 2018, pp. 1-6.
[34] J. Guo, C. Yang, and I. Chih-Lin, “Exploiting future radio resources with end-to-end prediction by deep learning,” IEEE Access, vol. 6, pp. 75729-75747, 2018.
[35] S. Hochreiter and J. Schmidhuber, “Long short-term memory,” Neural Comput., vol. 9, no. 8, pp. 1735-1780, 1997.
[36] H. D. Trinh, L. Giupponi, and P. Dini, “Mobile traffic prediction from raw data using LSTM networks,” in Proc. 29th IEEE Annu. Int. Symp. Pers. Indoor Mob. Radio Commun. (PIMRC), 2018, pp. 1827-1832.
[37] A. Azari, F. Salehi, P. Papapetrou, and C. Cavdar, “Energy and resource efficiency by user traffic prediction and classification in cellular networks,” IEEE Trans. Green Commun. Netw., vol. 6, no. 2, pp. 1082-195 June 2022.
[38] S. Wu, Z. Zeng, and H. Xia, “Coalition-based sleep mode and power allocation for energy efficiency in dense small cell networks,” IET Commun., vol. 11, no. 11, pp. 1662-1670, 2017.
[39] J. Kim, W. S. Jeon, and D. G. Jeong, “Effect of base station-sleeping ratio on energy efficiency in densely deployed femtocell networks,” IEEE Commun. Lett., vol. 19, no. 4, pp. 641-644, April 2015.
[40] Y. Li, H. Celebi, M. Daneshmand, C. Wang, and W. Zhao, “Energy-efficient femtocell networks: Challenges and opportunities,” IEEE Wireless Commun., vol. 20, no. 6, pp. 99-105, December 2013.
[41] A. D. Wyner, “Shannon-theoretic approach to a Gaussian cellular multiple-access channel,” IEEE Trans. Inf. Theory, vol. 40, no. 6, pp. 1713-1727 November 1994.
[42] L. Saker, S.-E. Elayoubi, R. Combes, and T. Chahed, “Optimal control of wake up mechanisms of femtocells in heterogeneous networks,” IEEE J. Sel. Areas Commun., vol. 30, no. 3, pp. 664-672, April 2012.
[43] G. Wu, G. Feng, and S. Qin, “Cooperative sleep-mode and performance modeling for heterogeneous mobile network,” in Proc. IEEE Wireless Commun. Netw. Conf. Workshops (WCNCW WKSHPS), 2013, pp. 6-11.
[44] J. Wu, E. W. Wong, Y.-C. Chan, and M. Zukerman, “Power consumption and GoS tradeoff in cellular mobile networks with base station sleeping and related performance studies,” IEEE Trans. Green Commun. Netw., vol. 4, no. 4, pp. 1024-136 December 2020.
[45] J. Wu, Y. Zhang, M. Zukerman, and E. K.-N. Yung, “Energy-efficient base-stations sleep-mode techniques in green cellular networks: A survey,” IEEE Commun. Surveys Tuts., vol. 17, no. 2, pp. 803-826, 2nd Quart., 2015.
[46] P. Ren and M. Tao, “A decentralized sleep mechanism in heterogeneous cellular networks with QoS constraints,” IEEE Wireless Commun. Lett., vol. 3, no. 5, pp. 509-512, October 2014.
[47] J. Kim, W. S. Jeon, and D. G. Jeong, “Base-station sleep management in open-access femtocell networks,” IEEE Trans. Veh. Technol., vol. 65, no. 5, pp. 3786-3791 May 2016.
[48] Y. S. Soh, T. Q. Quek, M. Kountouris, and H. Shin, “Energy efficient heterogeneous cellular networks,” IEEE J. Sel. Areas Commun., vol. 31, no. 5, pp. 840-850, May 2013.
[49] H. Zhang, Y. Wang, H. Ji, and X. Li, “A sleeping mechanism for cacheenabled small cell networks with energy harvesting function,” IEEE Trans. Green Commun. Netw., vol. 4, no. 2, pp. 497-505, June 2020.
[50] A. M. Alqasir and A. E. Kamal, “Cooperative small cell HetNets with dynamic sleeping and energy harvesting,” IEEE Trans. Green Commun. Netw., vol. 4, no. 3, pp. 774-782, September 2020.
[51] X. Li and C. Zhang, “Semi-dynamic Markov approximation-based base station sleep with user association for heterogeneous networks,” IET Commun., vol. 17, no. 6, pp. 704-711, 2023.
[52] H. S. Dhillon, R. K. Ganti, F. Baccelli, and J. G. Andrews, “Modeling and analysis of K-tier downlink heterogeneous cellular networks,” IEEE J. Sel. Areas Commun., vol. 30, no. 3, pp. 550-560, April 2012.
[53] T.-C. Hou and V. Li, “Transmission range control in multihop packet radio networks,” IEEE Trans. Commun., vol. 34, no. 1, pp. 38-44, January 1986.
[54] B. Matérn, Spatial Variation, vol. 36. Berlin, Germany: Springer, 2013.
[55] M. E. Leinonen, M. Jokinen, N. Tervo, O. Kursu, and A. Pärssinen, “Radio interoperability in 5G and 6G multiradio base station,” in Proc. 92nd IEEE Veh. Technol. Conf. (VTC-Fall), 2020, pp. 1-5.
[56] A. Baddeley, I. Bárány, and R. Schneider, “Spatial point processes and their applications,” Stochastic Geometry (LNMCIME 1892). Berlin, Germany: Springer, 2007, pp. 1-75.
[57] B. Boots, K. Sugihara, S. N. Chiu, and A. Okabe, Spatial Tessellations: Concepts and Applications of Voronoi Diagrams. New York, NY, USA: Wiley, 2009.
[58] B. Sklar, “Rayleigh fading channels in mobile digital communication systems. I. Characterization,” IEEE Commun. Mag., vol. 35, no. 7, pp. 90-100, July 1997.
[59] F. Rashid-Farrokhi, K. R. Liu, and L. Tassiulas, “Transmit beamforming and power control for cellular wireless systems,” IEEE J. Sel. Areas Commun., vol. 16, no. 8, pp. 1437-1450 October 1998.
[60] C. E. Shannon, “A mathematical theory of communication,” Bell Syst. Technol. J., vol. 27, no. 3, pp. 379-423, 1948.
[61] G. Auer et al., “How much energy is needed to run a wireless network?” IEEE Wireless Commun., vol. 18, no. 5, pp. 40-49, October 2011.
[62] J. Schmidhuber, “Deep learning in neural networks: An overview,” Neural Netw., vol. 61, pp. 85-117, January 2015.
[63] Y. Bengio, P. Simard, and P. Frasconi, “Learning long-term dependencies with gradient descent is difficult,” IEEE Trans. Neural Netw., vol. 5, no. 2, pp. 157-166, March 1994.
[64] S. Hochreiter, “The vanishing gradient problem during learning recurrent neural nets and problem solutions,” Int. J. Uncertainty Fuzziness Knowl.-Based Syst., vol. 6, no. 2, pp. 107-116, 1998.
[65] J. Hu, W. Heng, G. Zhang, and C. Meng, “Base station sleeping mechanism based on traffic prediction in heterogeneous networks,” in Proc. Int. Telecommun. Netw. Appl. Conf. (ITNAC), 2015, pp. 83-87.
[66] L. Li and W. Meng, “Collaborative base station sleeping solution design in heterogeneous cellular network,” in Proc. 27th Asia Pac. Conf. Commun. (APCC), 2022, pp. 231-235.
[67] X. Chen, Y. Jin, S. Qiang, W. Hu, and K. Jiang, “Analyzing and modeling spatio-temporal dependence of cellular traffic at city scale,” in Proc. 25th IEEE Int. Conf. Commun. (ICC), 2015, pp. 3585-3591.
[68] MathWorks. “Regression output layer-MATLAB regressionLayer.” 2017. Accessed: Mar. 10, 2023. [Online]. Available: https://www.mathworks.com/help/deeplearning/ref/regressionlayer.html
[69] S. Siami-Namini, N. Tavakoli, and A. S. Namin, “A comparison of ARIMA and LSTM in forecasting time series,” in Proc. 17th IEEE Int. Conf. Mach. Learn. Appl. (ICMLA), 2018, pp. 1394-1401.
[70] S. Siami-Namini, N. Tavakoli, and A. S. Namin, “A comparative analysis of forecasting financial time series using ARIMA, LSTM, and BILSTM,” 2019, arXiv: 1911.09512.
[71] P. T. Yamak, Y. Li, and P. K. Gadosey, “A comparison between ARIMA, LSTM, and GRU for time series forecasting,” in Proc. 2nd Int. Conf. Algorithms, Comput. Artif. Intell., 2019, pp. 49-55.

### SUMMARY OF INVENTION

Accordingly, the present invention, in one aspect, is a method of managing Base Stations (BSs) in a two-tier HeCN. The HeCN includes a plurality of MaBSs and a plurality of MiBSs. The method includes the steps of a) predicting future traffic for a user of the HeCN; b) shifting the user's connection from an under-utilized one of the plurality of MiBSs to one or more of other ones of the plurality of MiBSs or of the plurality of MaBSs; and c) powering down the under-utilized one of the plurality of MiBSs.

In some embodiments, Step a) is performed using a Bidirectional Long Short-Term Memory (BLSTM) neural network.

In some embodiments, the BLSTM neural network contains two layers. One of the two layers is adapted to transmit information in order of time, and the other one of the two layers is adapted to transmit information in reverse order of time.

In some embodiments, during Step b) the user's QoS requirement is guaranteed.

In some embodiments, during Step b) a Signal-to-Interference-plus-Noise Ratio (SINR) threshold of the user is not violated.

In some embodiments, Step b) further includes: e) identifying a MaBS from the plurality of the MaBSs that has a highest SNIR; and f) relocating the user's connection from the under-utilized one of the plurality of MiBSs to the MaBS.

In some embodiments, Step b) further includes: g) identifying a second MiBS from the plurality of the MiBSs that has a highest load; and h) relocating the user's connection from the under-utilized one of the plurality of MiBSs to the second MiBS.

In some embodiments, during Step b) a maximum traffic demand rate of the user is always met.

In some embodiments, Step b) further includes: i) identifying a BS from the plurality of the MiBSs and the plurality of MaBSs that is able to meet the maximum traffic demand rate during a low-load period; and j) relocating the user's connection from the under-utilized one of the plurality of MiBSs to the base station.

In some embodiments, the method further includes a step of modelling deployment of the MaBSs and MiBSs as a random point process.

In some embodiments, the random point process contains a Poisson Point Process (PPP) and a Matérn Hard-Core Point Process (MHCPP).

In some embodiments, at any time there is no one of the plurality of MaBSs that is powered down.

In some embodiments, the method further includes repeating Steps a)-c) for a different user.

In some embodiments, the method further includes repeating Steps a)-c) until no more of the of the plurality of MiBSs can be powered down.

According to another aspect of the invention, there is provided a non-transitory computer-readable memory recording medium having computer instructions recorded thereon, the computer instructions, when executed on one or more processors, causing the one or more processors to perform operations according to the methods described above.

According to a further aspect of the invention, there is provided a computing system which includes one or more processors; and memory containing instructions that, when executed by the one or more processors, cause the computing system to perform operations according to the methods described above.

One can see that embodiments of the invention therefore demonstrate effectiveness and superiority over other baseline strategies. Recognizing that real-time traffic within a cellular network fluctuates and often exhibits tidal patterns, such as day/night traffic flows, this characteristic is leveraged to minimize energy consumption. The approach involves strategically consolidating workloads distributed across the network onto fewer BSs.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figures, of which:

FIG. 1 illustrates the architecture of a HeCN.

FIG. 2a shows BS deployment realized by PPP in a 10 km×10 km area with MaBS intensity 0.2 points/km² and MiBS intensity 0.4 points/km², respectively.

FIG. 2b shows BS deployment realized by MHCPP based on the PPP in FIG. 2a with the hard-core parameter rₕ set as 1 km and 2 km for MaBS and MiBS, respectively.

FIG. 3a is a block diagram of the power consumption of a MaBS in Active mode.

FIG. 3b is a block diagram of the power consumption of the MaBS in Sleep mode.

FIG. 4a illustrates the repeating module of a standard RNN.

FIG. 4b illustrates the repeating module of a standard LSTM.

FIG. 5 illustrates the architecture of a BLSTM according to one embodiment of the invention.

FIG. 6 shows the algorithm of MiLSF strategy ϕ* in a two-tier HeCN.

FIG. 7a shows the hourly average traffic rates prediction by BLSTM for User 1, MAE=75.56, RMSE=98.32.

FIG. 7b shows the hourly average traffic rates prediction by BLSTM for User 2, MAE=55.78, RMSE=75.17.

FIG. 7c shows the hourly average traffic rates prediction by BLSTM for User 3, MAE=99.26, RMSE=115.23.

FIG. 8a shows the hourly average traffic rates prediction by RNN for User 1, MAE=87.89, RMSE=135.52.

FIG. 8b shows the hourly average traffic rates prediction by RNN for User 2, MAE=68.07, RMSE=118.93.

FIG. 8c shows the hourly average traffic rates prediction by RNN for User 3, MAE=104.99, RMSE=179.61.

FIG. 9a shows the hourly average traffic rates prediction by ARIMA for User 1, MAE=257.931, RMSE=460.085.

FIG. 9b shows the hourly average traffic rates prediction by ARIMA for User 2, MAE=221.24, RMSE=339.779.

FIG. 9c shows the hourly average traffic rates prediction by ARIMA for User 3, MAE=221.132, RMSE=332.755.

FIG. 10 is a comparison of energy-saving performance between MiLSF and the four baseline strategies under both PPP and MHCPP conditions.

FIG. 11 shows a performance comparison between MiLSF and the four baseline strategies across different user numbers.

FIG. 12 shows a performance comparison between MiLSF and the four baseline strategies across different SINR thresholds γ0.

FIG. 13 shows a performance comparison between MiLSF and the four baseline strategies across different numbers of sleeping MiBSs.

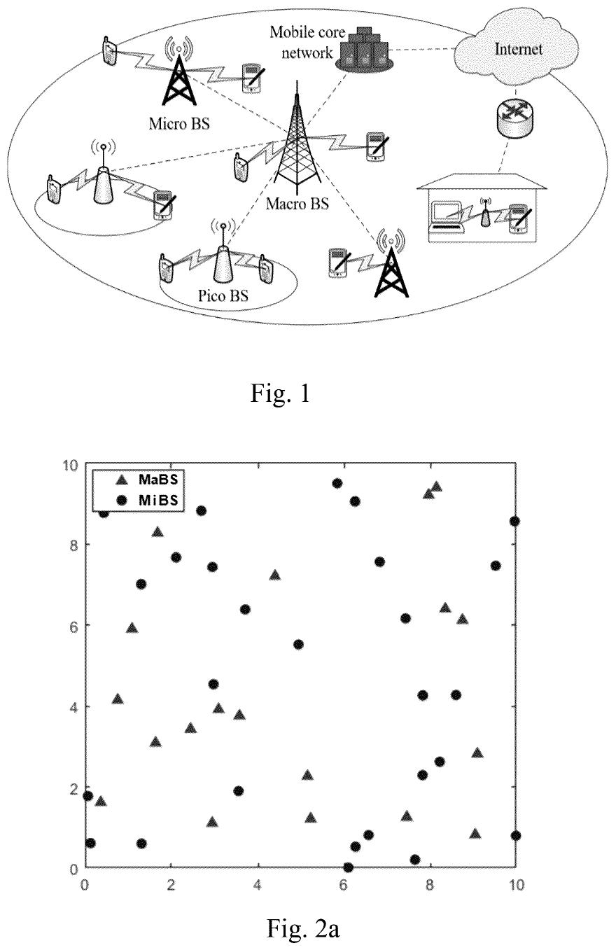

### DETAILED DESCRIPTION OF PREFERRED EMBODIMENTS

Real-time traffic in a cellular network varies over time and often shows tidal patterns, such as the day/night traffic pattern. With this characteristic, it is possible to reduce the energy consumption of a cellular network by consolidating workloads spreading over the entire network to fewer BSs. In one embodiment, there is proposed a BS sleeping strategy for a two-tier HeCN that consists of MaBS and MiBS. The sleeping strategy involves consolidating workloads distributed across the network onto fewer BSs. A BLSTM neural network is used, which predicts future traffic for each user. The predicted traffic data informs the BS sleeping strategy, which shifts user connections from under-utilized MiBSs to other BSs, subsequently powering down the idle MiBSs, while MaBSs remain always on. This strategy is executed with utmost consideration for maintaining service quality, ensuring that the switch does not degrade each user's Signal-to-Interference-plus-Noise Ratio thresholds or traffic demand rate.

In particular, in an exemplary embodiment the BLSTM neural network is used to predict the future traffic of each user. Based on the predicted traffic, the BS sleeping strategy switches user connections from underutilized MiBSs to other BSs, then switches off the idle MiBSs. The MaBSs are never switched off. All user connections have predefined SINR thresholds, and each user's service quality is ensured, which is related to the user's traffic demand rate, that it is not degraded when switching user connections. The effectiveness and superiority of the BS sleeping strategy over four other baselines through extensive numerical simulations is demonstrated, where the BS sleeping strategy substantially outperforms the four baselines in different scenarios in diverse scenarios, showcasing its potential to significantly reduce energy consumption in cellular networks without compromising service quality.

In the exemplary embodiment of the invention, the main advantages of the BS sleeping strategy in HeCNs include but not limited to the follows.
A BLSTM is used to predict the traffic demand rates of each user in the HeCN rather than predicting the traffic of the whole network or individual BSs as done in prior literature. real historical traffic data sets is used for training and testing the prediction model. The predicted traffic is then used as the input for the BS sleeping strategy. Based on stochastic geometry, the deployment of BSs in HeCNs is abstracted to a random point process. Specifically, a two-tier HeCN consisting of MaBSs and MiBSs is considered, and a PPP and a MHCPP are used to model the positions of BSs, respectively. The energy-saving performance of the two-tier HeCN is then evaluated under different BS deployment methods, namely PPP and MHCPP.
Given the predicted user traffic demand and the deployment results of BSs, the BS sleeping strategy is designed, which is referred to as Minimum Load Sleep First (MiLSF) strategy, for the two-tier HeCN. In this strategy, it is attempted to reallocate users of MiBSs in the network to other BSs and turn the idle MiBSs into sleep mode to minimize the overall energy consumption of the whole network. Each user connection is considered to have a predefined SINR. Each user's QoS requirement is guaranteed, which is related to the user's demand traffic rate, by ensuring the SINR does not violate the given threshold when switching the connection from one BS to another. The goal is to optimize the selection of the set of MiBSs that are switched to sleep mode at the beginning of a low-load period and then are switched back to active mode once the low-load period ends. In practice, the low-load period is normally at night. This design avoids frequent BS switching changes, which are problematic because of initialization requirements during switching from sleep to active mode. Notice that MaBSs in the network will not be switched to sleep mode, and the MiLSF strategy is implemented to not degrade all users' QoSs after reallocating the users.

The MiLSF strategy effectively reduces energy consumption and operating expenses for the HeCN. This, in turn, helps to reduce carbon emissions, making it an environmentally friendly solution. When combined with AI techniques to predict future traffic, the MiLSF strategy can help ensure QoS by proactively avoiding violations of the SINR threshold provided to each user. This proactive approach helps to prevent potential client loss and revenue loss for mobile carriers, thus making it a highly desirable solution for improving network performance.

Deploying MiBSs in MaBSs can improve user satisfaction, network capacity, network coverage, and reliability of HeCNs. However, existing studies on green HeCNs did not consider the movement of users and the variability of the traffic load generated by these users over time. On the other hand, traffic prediction is usually realized by analyzing the network traffic pattern and extracting traffic changes' characteristics. Since cellular network traffic is usually presented as time series, time series modeling methods can describe and predict changes in cellular network traffic. Moreover, the emergence of many neural network methods provides new ideas for modeling and predicting cellular network traffic. LSTM is a particular Recurrent Neural Network (RNN) that successfully addresses the gradient disappearance problem and easily learns long-term dependent information. Specifically, LSTM feeds the previous step's output to the current step's input layer, a dynamic feedback connection that models dependencies in a time series. However, existing publications focus more on the traffic prediction of BSs or the entire network without considering individual users' traffic demands.

In HeCNs, considering the high flexibility of MiBSs and the case of switching on and off, sleep strategies are usually applied to MiBSs to reduce the overall energy consumption of the networks. BS sleeping strategies must ensure that the active BSs can bear the network's traffic load when reducing energy consumption. The dynamic change of the network traffic load is an essential reference basis for formulating the sleeping strategies of the BSs. The sleeping of BSs needs to ensure the QoS of users and user associations with the remaining active BSs.

In summary, research on BS sleeping strategies mainly considers the traffic load of BSs, resource allocation, and user association. Researchers use greedy algorithms, heuristic algorithms, or game theory to obtain energy-saving sleeping strategies to maintain user satisfaction. Most of the current BS sleeping strategies are based on traffic prediction of BSs rather than individual users with different traffic demands in the network. The traffic prediction for different users can help formulate BS sleeping strategies that accurately meet the needs of different users. Meanwhile, the impact of different deployment methods of MaBSs and MiBSs in heterogeneous networks on user association and energy consumption has not been studied in depth. In the exemplary embodiment of the invention, based on the BLSTM predicted traffic data of every user with different traffic patterns in the network, the MiLSF strategy selectively sleeps some MiBSs and considers the user association problem, thereby reducing the energy consumption in the network without reducing the QoS of every user.

### System Model

The introduction of different types of BSs in HeCNs has led to the development of multi-layer network structures, which includes multiple types of BSs. In an exemplary embodiment of the invention a two-tier HeCN consisting of MaBSs and MiBSs is considered. In the following, the details of the two-tier HeCN and the BLSTM-based model for user traffic prediction are described.

### A. BS Deployment

Compared to the traditional cellular topologies where MaBSs use a hexagonal grid model and the MiBSs are deployed within the MaBSs' coverage in a specific way, the stochastic geometry theory provides an effective and tractable way to study the HeCNs' performance from a statistical perspective [19], [52]. Specifically, PPP is a tractable and popular point process due to its independence [53]. The PPP can be used to model the deployment process of the BSs of cellular networks, while MHCPP [54], which is based on PPP but avoids points being too close, can better reflect the BSs' deployment in actuality and describe the network more practically. In the exemplar embodiment both a PPP and an MHCPP in a two-dimensional Euclidean plane are considered to deploy the BSs.
PPP: The deployment process of BSs Φ={Bᵢ; i=1, 2, . . . } in a two-dimensional Euclidean plane [symbol] ² can be modeled as a PPP if the number of the BSs in any two-dimensional compact set [symbol] ⊂ [symbol] ² is a Poisson random variable, where Bᵢ is the i^{th} BS. Specifically, the MaBSs and MiBSs are deployed by applying different intensity values to a PPP. Notice that the deployments of MaBSs and MiBSs are independent of each other.
MHCPP: The MHCPP is based on the PPP but avoids interference between very close BSs by removing the points that coexist within a predefined non-negative distance (also known as the hard-core parameter rₕ), namely ∥Bᵢ−Bⱼ∥≥r^{h}, ∀Bᵢ, Bⱼ∈Φ, i≠j, rₕ≥0. Specifically, for any two BSs Bᵢ and Bⱼ separated by less than rₕ, the BS is removed with a smaller subscript, which is Bᵢ if i<j.

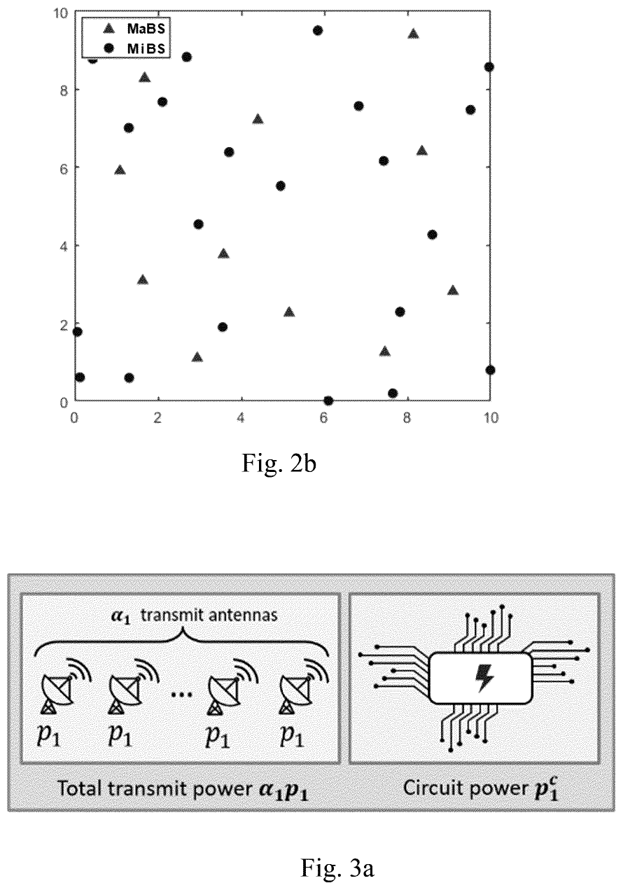

The realization of a PPP and an MHCPP for the BSs' deployment is illustrated in FIGS. 2a-2b. The deployment processes for MaBSs and MiBSs are independent of each other. Different intensities for MaBS and MiBS are used because of MaBS's higher transmitting power and larger coverage area, which resulted in fewer than MiBS in the actual deployment. One can observe from FIG. 2a that BSs of the same type may exist within a very close range, resulting in considerable signal interference. This situation is improved in FIG. 2b by removing BSs of the same type that are too close together. It should be noted that, for ease of exploration, only the signal interference among the same type BSs is considered. This is because, as mentioned above, MaBS and MiBS are characterized by entirely different carrier frequencies, so the interference among different types of BSs can be ignored compared with the interference among the same type of BSs.

Nevertheless, it is worth mentioning that for the actual scenarios of 5G or future 6G high-density BS networks, the increase in carrier frequency and the shortening of the wavelength of the BSs hasten the attenuation during signal propagation. Compared to 4G BSs, the coverage of 5G and 6G BSs is significantly reduced [55]. These characteristics suggest that while increasing the BS density in the MHCPP model, one could employ a smaller hard-core constraint distance, thereby lending the MHCPP model scalability in the high-density network practical scenarios of 5G or even 6G architecture.

Another limitation of the MHCPP model is that it assumes a specific form of spatial dependence characterized by a correlation structure [54], [56], which may not fully capture the complex spatial dependencies present in real-world scenarios. To address this limitation, alternative models, such as Voronoi Tessellation [57] and network-based models, offer more flexibility in capturing complex spatial dependence patterns. Voronoi tessellation divides space into regions around each base station, ensuring that any point within each region is closer to its corresponding base station than any other [57]. This model effectively captures the spatial interaction between base stations and provides a more accurate representation of coverage areas and interference patterns. It takes into account the proximity of users to individual base stations and enables the analysis of signal strength and interference levels. Network-based models explicitly consider the underlying network structure and connectivity between base stations. Graph-based models, such as random geometric graphs or random connection models, capture the spatial proximity of base stations and their connectivity patterns. These models are particularly useful for modeling wireless networks with interference, signal propagation, and connectivity constraints.

### B. SINR Model

In the exemplary embodiment, it is assumed that all homogeneous BSs have the same characteristics. The MaBSs and MiBSs are characterized by different deployment intensities, transmit powers, number of contained transmit antennas, carrier frequencies, and bandwidths.

Consider K users, M MaBSs, and N MiBSs in the two-tier HeCN, where
the transmit powers of a single transmit antenna in MaBSs and MiBSs are represented by p₁ and p₂;
the carrier frequencies of MaBSs and MiBSs are characterized by f₁^{c} and f₂^{c};
the bandwidths of MaBSs and MiBSs are denoted as w₁ and w₂.

For clarity of presentation, define sets Ψ_{M}={1, 2, . . . , M} and Ψ_{S}={M+1, M+2, . . . , M+N}, and the MaBSs and MiBSs in the two-tier HeCN are tagged as Bᵢ, i∈Ψ_{M} and Bᵢ, i∈Ψ_{S}, respectively. Let Ψ_{K}={1, 2, . . . , K} be the set of users in the two-tier HeCN. Since MiBSs and MaBSs have different characters (e.g., they use different carrier frequencies and different bandwidths), a binary indicator θ(x) is introduced to clarify it, which indicates which tier a BS belongs to, defined as:

$$θ ( x ) = \{ \begin{matrix}1 , & x ∈ {Ψ}_{M} , \\ 2 , & x ∈ {Ψ}_{S} .\end{matrix} \qquad ( 1 )$$

Consider user k∈Ψ_{K} who is allocated to BS i∈Ψ_{M} ∪Ψ_{S}, its path loss (dB) is obtained by

$${L}_{i , k} = 20 log ( \frac{4 π {f}_{θ ( i )}^{c}}{c} ) + 10 βlog ( {d}_{i , k} ) , \qquad ( 2 )$$

$$∀ k ∈ {Ψ}_{K} , i ∈ {Ψ}_{M} ⋃ {Ψ}_{S} ,$$

where c is the speed of light, β is the pass loss exponent, f_{θ(i)}^{c} is the carrier frequency of BS i, and d_{i,k} is the distance between BS i and user k. Then the received SINR from BS i to user k is where c is

$${S}_{i , k} = \frac{{p}_{θ ( i )} {ρ}_{i , k} {L}_{i , k}^{- 1}}{{\sum }_{j ∈ {Ψ}_{M} ⋃ {Ψ}_{S} \backslash \{ i \}} {p}_{θ ( j )} {ρ}_{j , k} {L}_{j , k}^{- 1} + {η}_{o} {ω}_{θ ( i )}} , \qquad ( 3 )$$

∀k∈Ψ_{K}, i∈Ψ_{M}∪Ψ_{S},
where p_{θ(i)} and w_{θ(i)} are the transmit power and bandwidth of BS i, respectively. η₀ denotes the noise spectral density. ρ_{i,k} is the small-scale fading between user k and BS i where Rayleigh fading is considered that follows an exponential distribution [58]. In this context, user k will be blocked from BS i if the received SINR is lower than threshold γ₀. The numerator in (3) (i.e., p_{θ(i)}·ρ_{i,k}·L_{i,k}⁻¹) is the signal power received by user k from its associated BS i. The denominator consists of both interference power and white noise power. The interference power (i.e., Σ_{j∈Ψ}_{_{M}}_{∪Ψ}_{_{S}}_{\{i}} p_{θ(j)}ρ_{j,k}L_{i,k}⁻¹) is the signal power received by user k from other BSs, i.e., the BSs except BS i.

Different interference mitigation strategies have been used in a HeCN in order to improve the SINR performance, such as the beamforming technique [59]. Instead of a single antenna, an antenna array is used for signal transmitting or receiving in beamforming. The signals received by multiple antennas have different phases (and amplitudes) due to the different signal paths. The received signals are adjusted to be coherent by introducing appropriate delays such that different signals can enhance each other, achieving a channel gain much more than a single antenna can realize. In addition, other techniques, such as power control and resource allocation, can also be used to mitigate interferences and improve the quality of signals. However, the BS sleeping strategy according to the exemplary embodiment is provided as an effective strategy to save energy with guaranteed quality services. A simple and general SINR model is considered but detailed interference management techniques are not delved into. These mitigation techniques can be combined with the BS sleeping strategy by providing a different SINR threshold to the algorithm.

### C. BS Power Consumption Model

For a user k connected to BS i with a SINR no less than the threshold γ₀, namely S_{i,k}≥γ₀, according to Shannon-Hartley theorem [60], the required bandwidth of BS i by user k at moment t is

$${b}_{i , k} ( t ) = \frac{{r}_{k} ( t )}{{log}_{2} ( 1 + {S}_{i , k} )} , \qquad ( 4 )$$

where rₖ(t) is the demand rate of user k at moment t. (4) describes the relationship between the required bandwidth resources and the demand traffic rate of users. Notice that the S_{i,k} in (4) is expressed as a linear power ratio, not as logarithmic decibels. Let Ψ_{K}ⁱ(t) be the set of the users connected to BS i at the moment t. Then, the load of BS i at the moment t is obtained by

$${μ}_{i} ( t ) = {\sum }_{k ∈ {Ψ}_{K}^{i} ( t )} \frac{{b}_{i , k} ( t )}{{ω}_{θ ( i )}} . \qquad ( 5 )$$

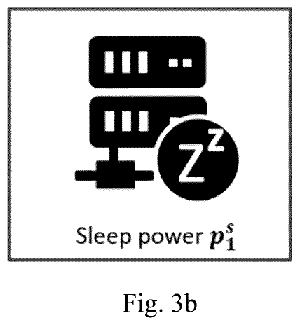

Notice that μᵢ(t)∈[0,1] since any BS is not allowed to be overloaded. For ease of exploration, two modes for a BS are considered: sleep mode and active mode, which are respectively shown in FIG. 3a and FIG. 3b. The following definitions are introduced.
P₁^{S} and P₂^{S} are defined as the sleep powers of MaBSs and MiBSs, respectively. The sleep powers are considered to be invariant with time and load because the BSs in sleep state will not bear any traffic load.
For active mode, P₁^{a} and P₂^{a} are defined as the active powers of MaBSs and MiBSs. The power of an active BS can be regarded as two parts, transmit power and circuit power [61], where the former is related to the load of BSs, and the latter contains the necessary circuit component energy consumption, which can be regarded as a constant. Specifically, p₁^{c} and p₂^{c} are defined as the circuit powers of MaBSs and MiBSs. It is assumed that every MaBS and MiBS consists of multiple transmit antennas, and the numbers of transmit antennas of every MaBS and MiBS are α₁ and α₂, respectively. In this context, the linear approximation model of [61] is used to represent the total power of BS i at moment t as follows.

$${P}_{θ ( i )}^{a} ( t ) = {α}_{θ ( i )} {p}_{θ ( i )} {μ}_{i} ( t ) + {p}_{θ ( i )}^{c} . \qquad ( 6 )$$

### D. BLSTM Model

The traffic patterns of users in cellular networks change over time [30]. RNN has gained significant attention in recent years [62] for handling sequence data as input and performing recursion in the direction of the evolution of the sequence. In RNNs, all the nodes (which are artificial neurons) are connected to allow the output of some nodes to impact the subsequent input to the same nodes. However, RNNs usually cannot handle long dependencies in reality, even with carefully chosen parameters, for very long sequences [35].

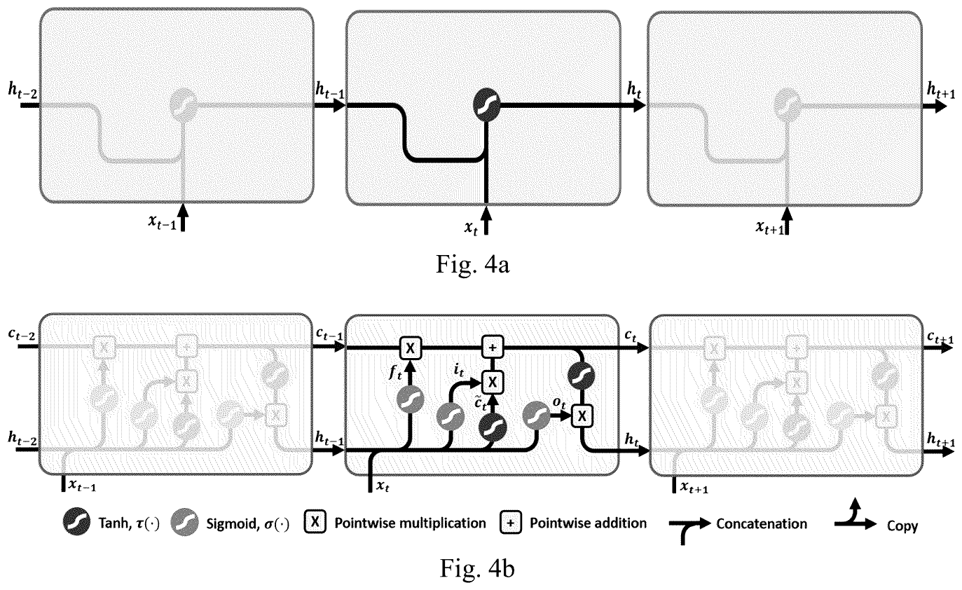

LSTM is an RNN designed to handle the long-term dependence problem that standard RNNs cannot handle [35]. LSTM lets the model learn how to forget the previous hidden state and update the current state, making it well-suited to capturing long-term temporal dependencies in sequences. The LSTM architecture includes forget, input, and output gate mechanisms that allow the model to forget or retain information selectively. FIGS. 4a-4b illustrate the differences between a standard RNN (scc FIG. 4a) and a standard LSTM (FIG. 4b) regarding their repeating models. At timet, xₜ, cₜ, \tilde{c}ₜ, hₜ, fₜ, iₜ, and oₜ represent the input, internal state, candidate state, hidden state, forget gate output, input gate output, and output gate output, respectively. The gate structure includes sigmoid and tanh activation functions, denoted by σ(·) and τ(·), respectively. The function called sigmoid compresses the input between 1 and 0, while the function called tanh compresses the input between 1 and −1. This feature allows LSTM to forget information by multiplying zero and memorize part or all of the information by multiplying a non-zero number.

For the repeating model described in FIG. 4(b) at time t, LSTM introduces an internal state cₜ∈ [symbol] ^{D} to linearly transfer the cyclic information and to output information non-linearly the cyclic information and to output information non-linearly to the hidden state hₜ∈ [symbol] ^{D}. The internal state cₜ and hidden state hₜ are obtained by

$${c}_{t} = {f}_{t} ⊙ {c}_{t - 1} + {i}_{t} ⊙ {\tilde{c}}_{t} , \qquad ( 7 )$$

$${h}_{t} = {o}_{t} ⊙ τ ( {c}_{t} ) , \qquad ( 8 )$$

where ⊙ is the pointwise multiplication operation, \tilde{c}∈ [symbol] ^{D} is the candidate state obtained by

$${\tilde{c}}_{t} = τ ( {W}_{c} {x}_{t} + {U}_{c} {h}_{t - 1} + {v}_{c} ) . \qquad ( 9 )$$

For the outputs of the three gates, there are provided
the forget gate output fₜ∈[0, 1]^{D}, which controls how much information needs to be forgotten for the last cell state cₜ−1,

$${f}_{t} = σ ( {W}_{f} {x}_{t} + {U}_{f} {h}_{t - 1} + {v}_{f} ) \qquad ( 10 )$$

the input gate output iₜ∈[0, 1]^{D}, which decides how much information needs to be memorized for a candidate state \tilde{c}ₜ,

$${i}_{t} = σ ( {W}_{i} {x}_{t} + {U}_{i} {h}_{t - 1} + {v}_{i} ) , \qquad ( 11 )$$

and the output gate output oₜ∈[0, 1]^{D}, which decides how much information the internal state cₜ needs to output to the hidden state hₜ,

$${o}_{t} = σ ( {W}_{o} {x}_{t} + {U}_{o} {h}_{t - 1} + {v}_{o} ) , \qquad ( 12 )$$

where the W_{*}, U_{*}, and v_{*}, U_{*}*∈{i, f, o, c} are the learnable network parameters. Concisely, (9)-(12) are described as

$$[ \begin{matrix}\tilde{{c}_{t}} \\ {o}_{t} \\ {i}_{t} \\ {f}_{t}\end{matrix} ] = [ \begin{matrix}τ ( \cdot ) \\ σ ( \cdot ) \\ σ ( \cdot ) \\ σ ( \cdot )\end{matrix} ] ( W [ \begin{matrix}{x}_{t} \\ {h}_{t - 1}\end{matrix} ] + v ) , \qquad ( 13 )$$

where xₜ∈ [symbol] ^{F} is the input at time t, W∈ [symbol] ^{4D*(D+F)} and v∈ [symbol] ^{4D} are the network parameters of LSTM. (13) together with (7)-(8) comprehensively describe a repeating model of a standard LSTM in FIG. 4(b).

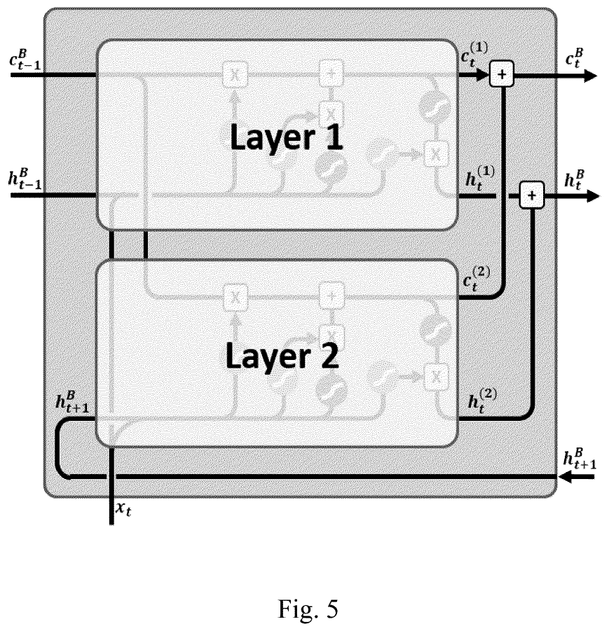

Although the standard LSTM described above is widely used in literature, not all LSTMs are the same. Different publications may use slightly different versions of the LSTM network, and the output at time t may be related to both past and future information. In an exemplary embodiment, the LSTM network's ability to predict user traffic data more accurately is enhanced using a BLSTM. A specific network layer that transmits information in reverse order of time is added, allowing the BLSTM to process both past and future context while making predictions. This modification improves the BLSTM's ability to capture temporal dependencies in the data and produces more accurate predictions than the standard LSTM. See FIG. 5. The two layers in FIG. 5 have different information transmission directions, where Layer 1 is in order of time, and Layer 2 is reversed in time. The internal state outputs (cₜ⁽¹⁾, cₜ⁽²⁾) and hidden state outputs (hₜ⁽¹⁾, hₜ⁽²⁾) of the two layers are obtained in the same vain of cₜ, and hₜ of the standard LSTM by (7), (8), and (13). Then, one can obtain the internal state output and hidden state output of BLSTM at time t by

$${h}_{t}^{B} = {h}_{t}^{( 1 )} ⊕ {h}_{t}^{( 2 )} , \qquad ( 14 )$$

$${c}_{t}^{B} = {c}_{t}^{( 1 )} ⊕ {c}_{t}^{( 2 )} , \qquad ( 15 )$$

where ⊕ is the concatenation operation.

The computational complexity of the BLSTM model depends on factors such as the input sequence length, the number of layers in the model, and the number of LSTM units in each layer. The time complexity of the BLSTM model can be high for long input sequences and models with many layers and LSTM units. It is worth mentioning that there are techniques to mitigate this complexity. For example, truncated backpropagation through time (TBPTT) can be employed during training to limit the number of time steps considered, reducing the overall computational burden [63], [64].

The BLSTM model also has some disadvantages compared to other types of RNNs, such as computational complexity, higher memory requirements, overfitting risks, and sensitivity to hyperparameters. However, considering that traffic prediction accuracy is very important in the technical problem, which may have a large influence on the performance of the sleeping strategy, the BLSTM model is chosen in the exemplary embodiment, which performs better than the RNN for the given dataset. Comparison of the accuracy of the BLSTM and the RNN models on the given dataset shows the superiority of the BLSTM model, which will be described in more detail below.

### Problem Formulation

It is aimed to reduce the total energy consumption of all BSs in the two-tier HeCN by selectively placing MiBSs in sleep mode during periods of low network load. To achieve this, three constraints are imposed: first, it is ensured that all users' SINRs remain above the threshold γ₀; second, it is ensured that there is no degradation in the QoS for each user, which is closely related to the demand traffic rates; and third, it is ensured that the load of each BS does not exceed 1.

Define an action vector aₜ^{ϕ}=(aₜ^{ϕ}(t), i∈Ψ_{M} ∪Ψ_{S}) as a state vector associated with strategy ϕ that
if aₜ^{ϕ}(t)=1, then BS i at time t is in active mode;
otherwise, BS i at time t is in sleep mode.

In this context, the set of all active BSs and sleeping BSs are [symbol] ^{active} (t)={i|aᵢ^{ϕ}(t)=1} and [symbol] ^{sleep}(t)={i|aᵢ^{ϕ}(t)=0}, respectively. Let Rₖ=max_{t∈[T}_{₁}_{,T}_{₂}_{]}rₖ(t), k∈Ψ_{K} be the set of maximum demand rates of users within low-load time period [T₁, T₂]. To mathematically define the feasibility of strategy ϕ during low-load time period [T₁, T₂], the following constraints are introduced for the action variables:

$$\{ \begin{matrix}{S}_{i , k} \geq {γ}_{0} \\ {μ}_{i} ( t ) + \frac{{R}_{k}}{{w}_{θ ( i )} {log}_{2} ( 1 + {S}_{i , k} )} \leq 1\end{matrix} , \qquad ( 16 )$$

$$∀ k ∈ {Ψ}_{K} , t ∈ [ {T}_{1} , {T}_{2} ] , ∃ i ∈ {𝒥}^{active} ( t ) .$$

Eq. (16) ensures that every user in the network has access to at least one active BS that can maintain an SINR above the threshold γ₀ while also being capable of accommodating the user's maximum traffic demand rate during the low-load period [T₁, T₂].

The different traffic demands of each user connected to an active BS jointly constitute a load of the BS. Since any BS is not allowed to be overloaded, thus

$$i ∈ {𝒥}^{active} ( t ) , 0 \leq {μ}_{i} ( t ) \leq 1 , ∀ t \qquad ( 17 )$$

$$∈ [ {T}_{1} , {T}_{2} ] .$$

Recall that only the sleeping operations on MiBSs are considered due to the high flexibility of MiBSs and the ease of switching on and off. This can be addressed by

$${𝒥}^{sleep} ( t ) ⋂ {Ψ}_{M} = ∅ , ∀ t ∈ [ {T}_{1} , {T}_{2} ] . \qquad ( 18 )$$

It is aimed to minimize the energy consumption of the BSs in the two-tier HeCN during a low-load time period [T₁, T₂]. Precisely, let

$$ℙ ( t ) = {\sum }_{i ∈ {Ψ}_{M} ⋃ {Ψ}_{S}} ( {a}_{i}^{ϕ} ( t ) {P}_{θ ( i )}^{a} ( t ) + ( 1 - {a}_{i}^{ϕ} ( t ) ) {P}_{θ ( i )}^{s} ) , \qquad ( 19 )$$

$$t ∈ [ {T}_{1} , {T}_{2} ] ,$$

be the total power of all BSs in the two-tier HeCN at time t∈[T₁, T₂], then the optimization problem is

$${min}_{ϕ} {\int }_{{T}_{1}}^{{T}_{2}} ℙ ( t ) dt , \qquad ( 20 )$$

subject to (16), (17), and (18). Let Φ represent the set of all strategies constrained by (16), (17), and (18).

### MiLSF Strategy

This section describes the MiLSF strategy based on the user traffic demands rₖ(t) predicted by BLSTM and the load of BSs μᵢ(t). Notice that only the sleeping operation on MiBSs is considered due to the high flexibility and ease of operation. Furthermore, the frequent switching of the state of BSs will cause additional network delay and extra energy consumption for BS initialization. Therefore, for the low-load period [T₁, T₂], only one sleep operation for the MiBSs is considered, which occurs at the start time of the low-load period, namely T₁. Before the T₁, it is assumed that all M MaBSs and N MiBSs are in active mode. As the low-load period is typically during the night period when human activity is low, the mobility of users is also very low. For simplicity, it is assumed that mobile terminals or users are stationary during this period.

The detailed implementation process of the MiLSF strategy is listed as follows.
1) Sorting. The active MiBSs are sorted based on their load situation at time T₁ from low to high.
2) Sleeping. Using the sorting order from Step (1), each MiBS is evaluated to determine whether it can be switched to sleep mode. If an active BS exists, including MaBSs and MiBSs, that can meet the maximum traffic demand rate during the low-load period [T₁, T₂] of every user currently connected to the MiBS, then the MiBS can be switched to sleep mode, and the method moves on to Step (3). Otherwise, the method will continue evaluating the next MiBS until a MiBS is found that can be switched to sleep mode.
3) User reallocation. Active BSs are selected, including MaBSs and MiBSs, that can meet the maximum traffic demand rate during the low-load period [T₁, T₂] of every user connected to the MiBS which will be switched to sleep mode in Step (2). The users are then reassigned to the selected active BSs. Preferentially each user is reallocated to the MaBS with the highest SINR among the selected BSs. If no qualified MaBS exists among the selected BSs, the user is reallocated to the MiBS with the highest load among the selected BSs.
4) Repeating. Steps (1) and (2) are repeated until no more MiBSs can be switched to sleep mode.
In Step (3), since the goal is to have as many MiBSs as possible in sleep mode, to save energy without degrading user service quality and sleeping any MaBS, priority is given to the active MaBS with the highest SINR among the selected BSs. Since all the MaBSs have the same power consumption characteristics, assigning users to the MaBS with the highest SINR can obtain the best spectral efficiency.

Suppose there is no active MaBS among the selected BSs in Step (3). In this case, users are reallocated to the MiBS with the maximum load, which helps speed up the execution process and reduce the complexity since the method always try to sleep the minimum load MiBS first in each cycle of the above execution.

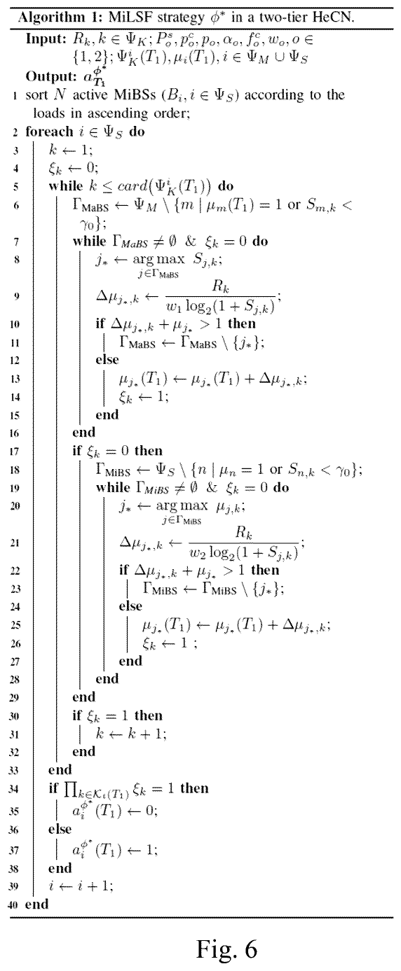

The pseudo-code of the MiLSF strategy ϕ* is proposed in the algorithm shown in FIG. 6. The tie-breaking rules in Line 8 and Line 20 of the algorithm can be arbitrary if argmax returns more than one argument, and card(·) returns the cardinality of a set.

### Numerical Results

In this section, the effectiveness of the MiLSF strategy is numerically demonstrated by comparing it with the following four other baseline strategies in different scenarios.
1) Randomly Sleep (RS). Active MiBSs (see Step (2) in the “MiLSF Strategy” Section above) are randomly selected to try to have them in sleep mode until no remaining MiBS can be switched to sleep mode. The user reallocation process of users in RS is the same as that in MiLSF (see Step (3) in the “MiLSF Strategy” Section).
2) Randomly Reallocate Users (RRU). The selection process of active MiBSs is the same as the selection process of active MiBSs in MiLSF (see Step (2) in the “MiLSF Strategy” Section), but under RRU, the users will be randomly reallocated to active BSs that meet the SINR threshold and can guarantee the users' traffic demand rates, which is different from Step (3) in MiLSF.
3) Closest User Reallocation (CUR) [65]. The CUR strategy always reallocates a user to the closest available BSs (including both MaBSs and MiBSs) that can guarantee the maximum traffic demand rate for this user during the low-load period [T₁, T₂] with an SINR larger than the threshold, while the selection of MiBSs follows the same principle of the MiLSF strategy (see Step (2) in the “MiLSF Strategy” Section).
4) Closest Base Station Sleep First (CBSSF). In the CBSSF strategy, the MiBS closer to the MaBSs is prioritized to consider sleep, while the user reallocation process is the same as that in MiLSF (see Step (3) in the “MiLSF Strategy” Section).

In the Part A of this section that will be discussed below, the traffic data source is introduced and the prediction of user traffic demand rates using BLSTM is demonstrated. In the Part B of this section, the superiority of the MiLSF strategy over RS and RRU in different scenarios is demonstrated. The 95% confidence intervals are obtained based on the Student's t-distribution for the results on energy-saving percentages of MiLSF, RS, and RRU relative to the non-sleeping strategy, all within 2% of the observed mean.

### Part A; User Traffic Data Prediction by BLSTM

User traffic data are obtained from [67] by analyzing the week-long traffic data of medium-sized Chinese cities with large populations. To predict each user's traffic demand for the next day, their historical traffic demand rates over the past week are used for the modeling training. Specifically, each user's hourly average traffic rate dataset for eight consecutive days is split into two parts: the first seven days for training and the eighth day for testing.

The BLSTM neural network is used, which consists of an input layer for receiving user traffic data sequences, two LSTM layers with 500 hidden units each, a fully connected layer with an output size matching the input size, and a regression layer that computes the half-mean-squared-error loss for regression tasks [68]. The RMSProp is used as the optimizer when training the model, and the parameters, including the optimization algorithm, learning rate, and batch size, are set as default values of this optimizer.

To train the BLSTM neural network on the above-mentioned real-world user traffic data from [67], it is observed that user traffic exhibits a daily periodic characteristic. Thus, a special training approach is designed that utilizes this characteristic. Firstly, the model is trained on the user traffic of the first two days and used it to predict the traffic for the third day. The errors between the predicted and actual traffic are then recorded, and the model's parameters (such as gate parameters) are modified to minimize the errors after modification. With the modified model, the user traffic of the fourth day is predicted based on the traffic of the last two days (i.e., the second and third days), recorded the errors, and modified the model's parameters. These steps are repeated until all the traffic data for seven days are used, which marks the end of one round of training. The above round is repeated until the average error in this round was lower than a given threshold, thus completing the model training.

To assess the performance of the BLSTM neural network, two commonly used metrics are utilized: Mean Absolute Error (MAE) and Root Mean Square Error (RMSE). Specifically, MAE is obtained by the average of the absolute prediction errors, while RMSE is computed as the square root of the average of the squared prediction errors.

20% hold-out validation is employed to assess the performance of the BLSTM, RNN, and ARIMA models. Specifically, 20% of the user traffic data from is reserved for validation, while the remaining 80% is utilized for training. Table I presents the hold-out validation results of these three models on the validation set, where BLSTM shows great superiority for user traffic prediction over RNN and ARIMA with the lowest MAE and RMSE.

TABLE I
20% hold-out validation of the
BLSTM, RNN, and ARIMA models.

| | BLSTM | RNN | ARIMA |
|---|---|---|---|
| MAE | 62.23 | 79.81 | 232.46 |
| RMSE | 91.67 | 144.09 | 398.77 |

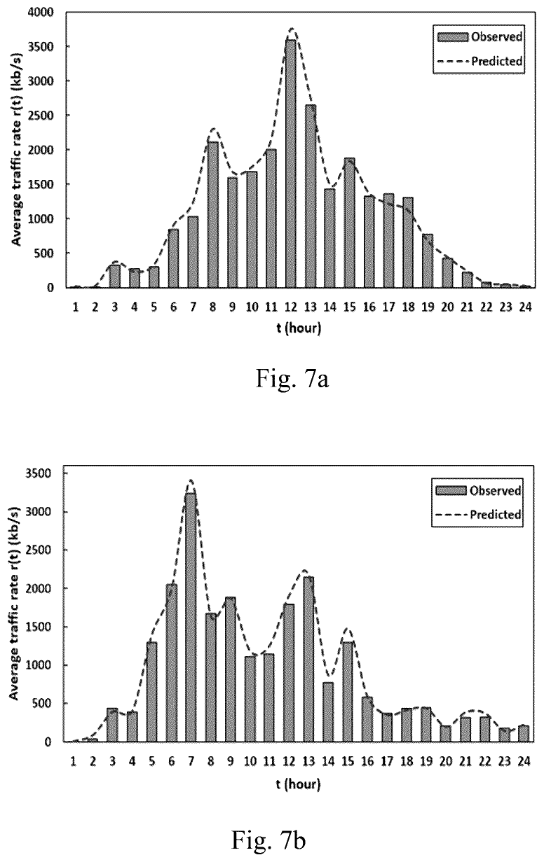

In FIGS. 7a-9c, the hourly traffic rate predictions for three users with distinct traffic patterns, as predicted by the BLSTM, RNN, and ARIMA models, are illustrated respectively. The results presented by each subfigure are based on the performance metrics MAE and RMSE. These figures serve to illustrate the prediction accuracy of each model for different traffic patterns.

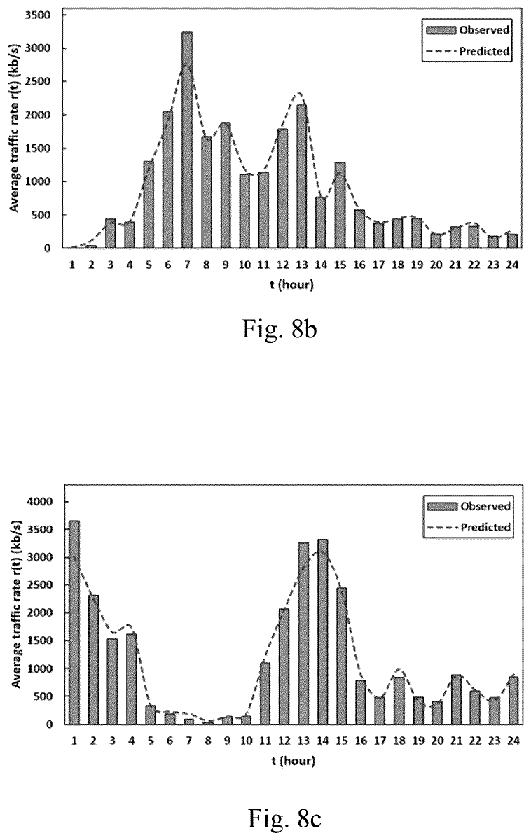

It can be seen that the prediction results of ARIMA as shown in FIGS. 9a-9c differ the most from the actual values, which can be observed both from the MAE and RMSE metrics. This is because ARIMA is a classic linear model, assuming that time series data has a linear relationship, but actual data may contain nonlinear relationships, thus may cause inaccurate prediction results for nonlinear time series [69], [70], [71]. The analysis of nonlinear time series requires using corresponding nonlinear models or methods to model and predict data, such as RNN and LSTM in neural network models.

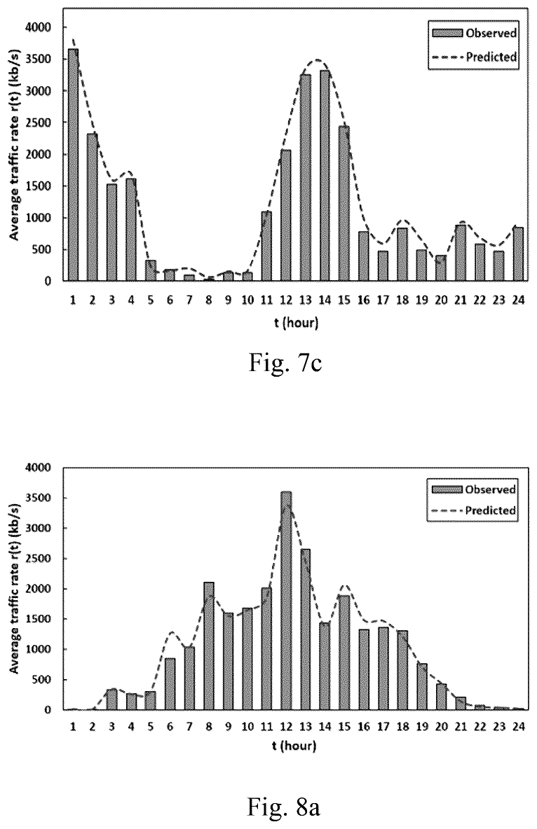

It is observed that the MAE of the prediction results for the three users is similar between RNN and BLSTM (BLSTM has a slight advantage over RNN), indicating comparable average prediction accuracy for both methods. However, BLSTM significantly outperforms RNN in predicting peak rates, as reflected by the much lower RMSE of BLSTM for the three users in FIGS. 7a-7c and FIGS. 8a-8c. Therefore, BLSTM is used to predict the future traffic rates of every user in the two-tier HeCN. Based on the predicted user traffic rates from BLSTM, the MiLSF strategy is implemented, and its superiority is demonstrated over RS and RRU strategies in different scenarios.

### Part B: Effectiveness of MiLSF

Here a comparison between the MiLSF strategy with the four baseline strategies, RS, RRU, CUR, and CBSSF in various scenarios is provided based on predicted data of user traffic rates by BLSTM. Simulation parameter values in Table II are used unless otherwise specified. Although different users have varying traffic demands at different times, most users typically have lower traffic demands at night, resulting in a lower overall network load during this period. This provides an opportunity for BS sleeping strategies to save energy and therefore, by considering night-time, it can be demonstrated the superiority of MiLSF over the four baseline strategies. Additionally, it is assumed that users do not move during the low-load period at night, as user mobility is significantly reduced during this time. The low-load period is considered to be between 10:00 p.m. and 6:00 a.m. the following day as the sleeping period. That is, a selected set of MiBSs enter sleep mode at 10:00 p.m. and enter active mode at 6:00 a.m., and it is aimed to select these MiBSs optimally. PPP is used to determine user locations. Each user is randomly allocated to a BS that meets the SINR threshold and the user's traffic demand rate for initialization. MiLSF, RS, RRU, CUR, and CBSSF strategies are then implemented during the low-load period and compare their energy-saving performances relative to a non-sleeping strategy. The numerical results demonstrate the effectiveness and superiority of MiLSF over the four baseline strategies.

Scenario I: In this scenario, the energy-saving performance of MiLSF with the four baseline strategies are compared under two different BS deployment methods. Specifically, for each strategy, two different deployment processes that are PPP and MHCPP are used to determine the locations of all BSs. It is important to note that the deployment processes of MaBSs and MiBSs are independent and have different intensities, as shown in Table II. By comparing the energy-saving performance of each strategy under these different deployment methods, it is possible gain insight into the effectiveness of each strategy under different BS deployment methods.

TABLE II
Simulation parameters.

| Description | Value | |
|---|---|---|
| The two-tier HeCN area | 10 × 10 | km² |
| Intensity of MaBSs for PPP deployment, λₘ^{PPP} | 2/km² | |
| Intensity of MiBSs for PPP deployment, λₛ^{PPP} | 4/km² | |
| Intensity of MaBSs for MHCPP deployment, λₘ^{MHCPP} | 2/km² | |
| Intensity of MiBSs for MHCPP deployment, λₛ^{MHCPP} | 4/km² | |
| Hard-core parameter for MaBSs, r_{h, m} | 2 | km |
| Hard-core parameter for MiBSs, r_{h, s} | 1 | km |
| Intensity of users in the HeCN for PPP deployment, λᵤ | 25/km² | |
| Transmit power of a single antenna in MaBSs, p₁ | 8 | W |
| Transmit power of a single antenna in MiBSs, p₂ | 3 | W |
| Number of transmit antennas in a MaBS, α₁ | 6 | |
| Number of transmit antennas in a MiBS, α₂ | 2 | |
| Carrier frequency of MaBSs, f₁^{c} | 2.4 | GHz |
| Carrier frequency of MiBSs, f₂^{c} | 20 | GHz |
| Bandwidth of a MaBS, w₁ | 20 | MHz |
| Bandwidth of a MiBS, w₂ | 50 | MHz |
| Circuit power of MaBSs, p₁^{c} | 120 | W |
| Circuit power of MiBSs, p₂^{c} | 10 | W |
| Sleep power of MaBSs, p₁^{s} | 8 | W |
| Sleep power of MiBSs, p₂^{s} | 2 | W |

| | |
|---|---|
| Path loss exponent, β | 3.7 |
| SINR threshold (dB), γ₀ | −6 |

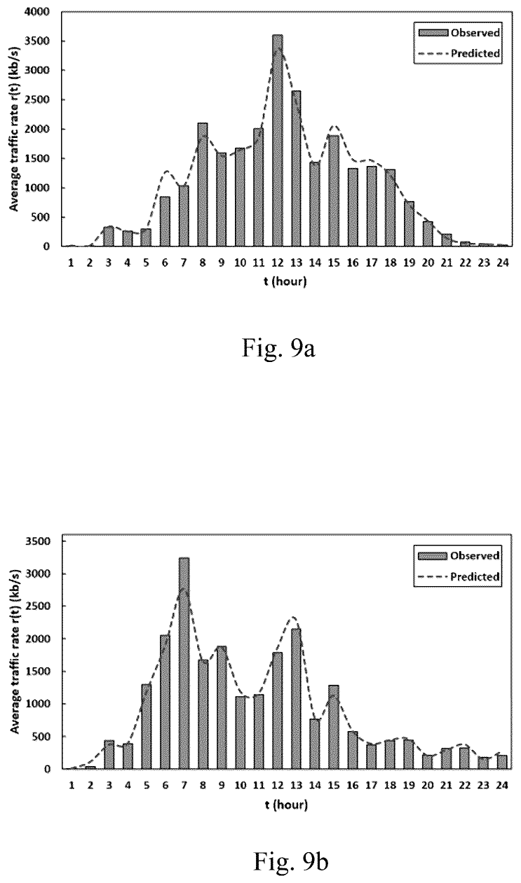

In FIG. 10, the effect of different BS deployment methods on the energy-saving performance of BS sleeping strategies is observed. The results show that MiLSF outperforms all the four baseline strategies under both PPP and MHCPP deployments. However, using MHCPP instead of PPP for BS deployment significantly increases the energy-saving percentage for the same strategy. For example, the MiLSF strategy achieves an energy-saving percentage of 5.82% under PPP deployment, but it achieves an energy-saving percentage of 11.26% under MHCPP deployment, almost twice that under PPP. The disadvantage of PPP is due to the presence of the same-type BSs that are too close to each other, resulting in significant signal interference. This reduces the number of selectable BSs for users in Step (3), resulting in a significant reduction in the number of MiBSs that can eventually be switched to sleep mode and a reduction in energy-saving percentages. Therefore, MHCPP is used for BS deployment in Scenarios II, III, and IV.

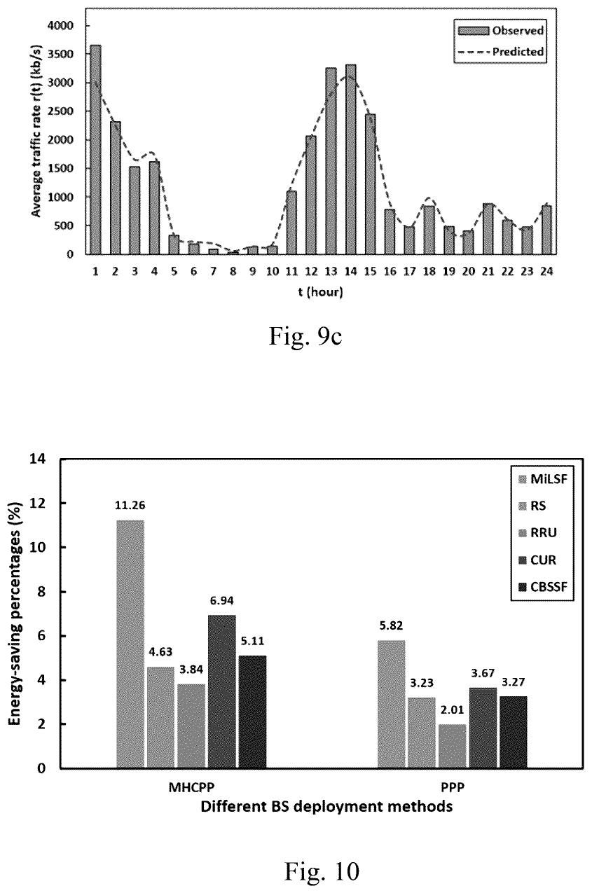

Scenario II: In this scenario, the effect of user loads on the energy-saving performance of MiLSF and the four baseline strategies is observed, by varying the user intensity λᵤ in FIG. 11.

FIG. 11 demonstrates the superiority of MiLSF over all the four baseline strategies, with MiLSF achieving higher energy-saving percentages under different numbers of users, particularly when the number of users is moderate. This is because, unlike RS, MiLSF always selects the MiBSs with the lowest load and reallocates connected users to other BSs. Sleeping the lowest-load MiBS is easier than high-load MiBSs, as users connected to the lowest-load MiBS are more likely to be “satisfied” and assigned to other BSs. Prioritizing user allocation of lowest-load MiBS to other BSs also reduces the likelihood of problems during subsequent sleep operations of other MiBSs. Additionally, MiLSF prioritizes user allocation to the MaBS with the maximum SINR, leading to higher energy-saving percentages than RRU, where users are reallocated to a random active BS that may not use full use of the MBS's bandwidth resource.

In the CBSSF strategy, MiBSs that are closest to the MaBSs are always prioritized for sleep consideration. Consequently, users previously associated with these MiBSs are most likely to be reallocated to the nearest corresponding MaBSs. This characteristic results in an overemphasis on MaBSs during the user reallocation process, triggering premature load saturation in the MaBSs. Concurrently, MiBSs that cannot transition to sleep mode (if one user solely relies on a particular MiBS and can not be allocated to other BSs) remain underutilized, operating in a low-load working state without the option to enter sleep mode. This situation reduces the total number of MiBSs that can ultimately be switched to sleep mode, significantly diminishing the energy-saving percentage compared to that achieved by the MiLSF strategy.

As for the CUR strategy, it simply reallocates users to the BSs that are closest to them and can guarantee the maximum user traffic demand with an SINR larger than the threshold. However, it overlooks the load distribution of each BS across the entire network and the different SINR situations that various BSs can offer. Unlike the MiLSF strategy, which fully considers the load information of all BSs in the network and the optimal SINR throughout its implementation, the CUR strategy does not achieve as effective global optimization in energy saving across the network as MiLSF docs.

Furthermore, FIG. 11 shows that the energy-saving percentages of five strategies are similar when there are either no users or a large number of users (close to 400). This is because, under all the strategies, all the MiBSs sleep when the number of users is small, or remain in active mode when the number of users is large, resulting in similar energy-saving performance. Additionally, the more users in the network, the lower the energy-saving percentage of all five strategies, as fewer MiBSs can be switched to sleep mode.

Scenario III: In this scenario, the effect of the SINR threshold value γ₀ on the energy-saving performance of MiLSF and the four baselines in FIG. 11 is observed. The results show that MiLSF outperforms all four baselines under different SINR thresholds. Additionally, the energy-saving percentages of all five strategies gradually decrease as the SINR threshold increases, as the number of BSs that can be selected by each user for reallocation decreases, reducing the possibility of successfully reallocating all users of each MiBS and resulting in fewer MiBS that can be switched to sleep mode.

Moreover, the most significant difference in energy-saving percentages between MiLSF and the four baseline strategies occurs when the SINR threshold is moderate. When the SINR threshold is too large (i.e., γ₀=0 dB), very few active BSs can be selected to meet the SINR threshold for user reallocation in Step (3), making it challenging for all five strategies to reallocate users successfully. As a result, the difference in energy-saving percentages is small. Conversely, when the SINR threshold is too small (i.e., γ₀=−12 dB), almost all active BSs can become qualified active BSs for user reallocation in Step (3), making it easier for all five strategies to reallocate all users connected to a MiBS and achieve higher energy-saving percentages.

When the SINR threshold is moderate, the user reallocation in Step (3) cannot be too “arbitrary”, as there may be only a few (or even one) qualified active BSs for each user. In this case, MiLSF prioritizes the MaBS with the highest SINR, maximizing the probability of satisfying all users' demand traffic rates and sleeping as many MiBSs as possible. Therefore, when the SINR threshold is moderate, MiLSF has a significant energy-saving advantage versus RS, RRU, CUR, and CBSSF.

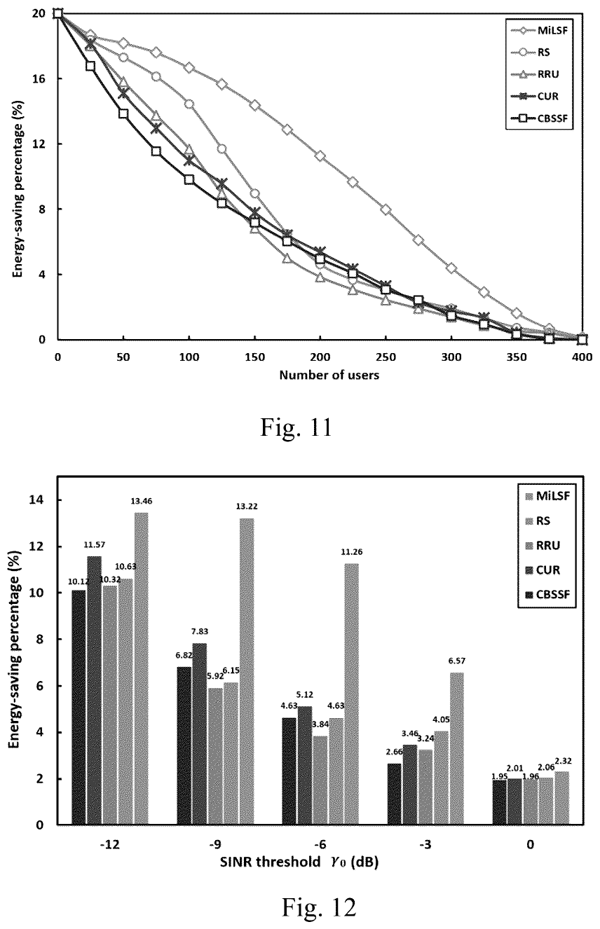

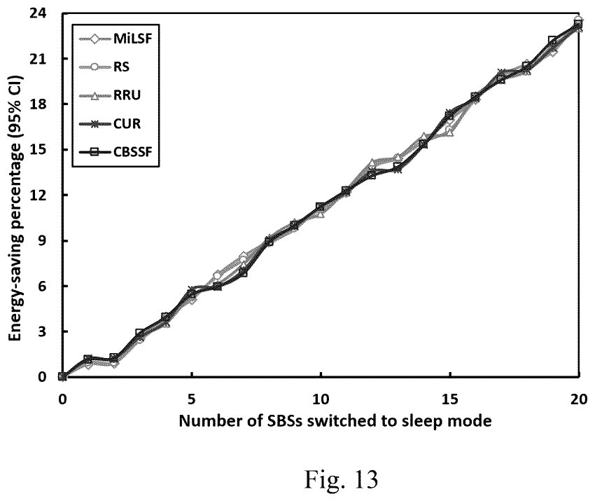

Scenario IV: In this scenario, the relationship between the number of sleeping MiBSs and the energy-saving percentages for five strategies is observed in FIG. 13. The results demonstrate a linearly positive correlation between the number of sleeping MiBSs and the energy-saving percentage. Notice that there is only a small difference in the energy-saving percentage among the five strategies with the same number of sleeping MiBSs. Because under MiLSF and the four baseline strategies, different MiBSs may sleep, resulting in different user reallocation situations (users may be reallocated to different MaBSs or MiBSs). This small difference in the energy-saving performances between MiLSF and the four baselines shows that if one only consider different BS sleeping strategies or user reallocations without switching more MiBSs to sleep mode, it is challenging to reduce energy consumption significantly. Therefore, a BS sleeping strategy that can have more MiBSs in sleep mode is always preferred. In this case, the results in FIG. 10, FIG. 11, and FIG. 12 illustrate that, given the network parameters, the MiLSF strategy can always achieve a higher energy-saving percentage than the four baseline strategies by sleeping more MiBSs, demonstrating its effectiveness and superiority over RS, RRU, CUR, and CBSSF.

### CONCLUSIONS

The above exemplary embodiment of the invention therefore proposed a new BS sleeping strategy named MiLSF for a two-tier HeCN, based on predicted traffic demand rates for each user. Underutilized MiBSs are switched to sleep mode, and users are reallocated to other active BSs that meet the SINR threshold and can guarantee the users' maximum demand traffic rates during the low-load period. BLSTM is used to predict each user's future traffic demand rates based on historical traffic data over the past week, achieving higher prediction accuracy than RNN, particularly for peak rates. MiLSF strategy has been implemented during a low-load period at night to explore its energy-saving performance in different scenarios. Specifically, the MiLSF strategy has always tried to have the least loaded MiBS in sleep mode and reallocate users to the MaBS with the highest SINR that can guarantee their traffic demand rates. Through extensive numerical simulations, it is demonstrated the effectiveness and superiority of the MiLSF strategy over the four baselines, RS, RRU, CUR, and CBSSF. Furthermore, although only one sleep operation for a two-tier HeCN has been considered, the MiLSF strategy can be extended to any multi-layer HeCNs for multiple sleep operations during various low-load periods.

While the exemplary embodiment above focuses on improving energy efficiency while guaranteeing the QoS of each service with a predefined SINR ratio, load balancing is an important aspect to consider in network design. Load balancing can help evenly distribute network traffic and improve the quality of service for end-users. Therefore while the QoS of each deployed service is ensured, combining the MiLSF strategy with load-balancing techniques could further improve the overall performance and efficiency of the network.

The above exemplary embodiment of the invention hold the following advantages over existing technologies and products available in the market:
More refined prediction: Unlike existing research that predicts the traffic of the entire network or a single BS, the embodiment uses BLSTM to predict the traffic demand rate of each user in the HeCN. This prediction method is more accurate as it considers the differences in traffic demand between users.
Superior BS sleeping strategy: The MILFS strategy is superior to existing BS sleeping strategies. By switching the least loaded MiBS to sleep mode first, this strategy can minimize the total energy consumption of the network.
Better network management: The embodiment considers the effect of different BS deployment methods on the performance of the sleep strategy and accomplishes full utilization of the MiBS in HeCN during sleep periods by controlling user selection. This method can achieve load balancing between BSs, resulting in more efficient network management and better network resource utilization.
Higher energy efficiency: The embodiment can significantly improve the energy efficiency of mobile cellular networks by optimizing the BS switching on/off and sleeping strategies, thereby reducing greenhouse gas emissions and saving considerable operational costs.

In summary, the invention provides a more efficient, accurate, and energy-efficient user traffic prediction and BS sleeping strategy, considerably superior to existing technologies and products in the market.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

The functional units and modules of the systems and methods in accordance with the embodiments disclosed herein may be implemented using computing devices, computer processors, or electronic circuitries including but not limited to application-specific integrated circuits (ASIC), field programmable gate arrays (FPGA), and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, and mobile computing devices such as smartphones and tablet computers.

The embodiments include computer storage media, transient and non-transient memory devices having computer instructions or software codes stored therein which can be used to program computers or microprocessors to perform any of the processes of the present invention. The storage media, transient and non-transitory computer-readable storage medium can include but are not limited to floppy disks, optical discs, Blu-ray Disc, DVD, CD-ROMs, magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in a distributed fashion by one or more processing devices interconnected by a communication network, such as an intranet, WAN, LAN, the Internet, and other forms of data transmission medium.

1. A method of managing Base Stations (BSs) in a two-tier Heterogeneous Cellular Networks (HeCN), the HeCN comprising a plurality of Macro Base Stations (MaBSs) and a plurality of Micro Base Stations (MiBSs); the method comprising steps of:
a) predicting future traffic for a user of the HeCN;
b) shifting the user's connection from an under-utilized one of the plurality of MiBSs to one or more of other ones of the plurality of MiBSs or of the plurality of MaBSs; and
c) powering down the under-utilized one of the plurality of MiBSs.

2. The method of claim 1, wherein Step a) is performed using a Bidirectional Long Short-Term Memory (BLSTM) neural network.

3. The method of claim 3, wherein the BLSTM neural network comprises two layers; one of the two layers being adapted to transmit information in order of time, and the other one of the two layers being adapted to transmit information in reverse order of time.

4. The method of claim 1, wherein during Step b), the user's Quality of Service (QOS) requirement is guaranteed.

5. The method of claim 3, wherein during Step b), a Signal-to-Interference-plus-Noise Ratio (SINR) threshold of the user is not violated.

6. The method of claim 5, wherein Step b) further comprises:
e) identifying a MaBS from the plurality of the MaBSs that has a highest SNIR; and
f) relocating the user's connection from the under-utilized one of the plurality of MiBSs to the MaBS.

7. The method of claim 5, wherein Step b) further comprises:
g) identifying a second MiBS from the plurality of the MiBSs that has a highest load; and
h) relocating the user's connection from the under-utilized one of the plurality of MiBSs to the second MiBS.

8. The method of claim 3, wherein during Step b), a maximum traffic demand rate of the user is always met.

9. The method of claim 8, wherein Step b) further comprises:
i) identifying a base station (BS) from the plurality of the MiBSs and the plurality of MaBSs that is able to meet the maximum traffic demand rate during a low-load period; and
j) relocating the user's connection from the under-utilized one of the plurality of MiBSs to the base station.

10. The method of claim 1, further comprises a step of modelling deployment of the MaBSs and MiBSs as a random point process.

11. The method of claim 4, wherein the random point process comprises a Poisson Point Process (PPP) and a Matérn Hard-Core Point Process (MHCPP).

12. The method of claim 1, wherein at any time there is no one of the plurality of MaBSs that is powered down.

13. The method of claim 1, further comprises repeating Steps a)-c) for a different user.

14. The method of claim 13, further comprises repeating Steps a)-c) until no more of the of the plurality of MiBSs can be powered down.

15. A non-transitory computer-readable memory recording medium having computer instructions recorded thereon, the computer instructions, when executed on one or more processors, causing the one or more processors to perform operations according to the method according to claim 1.

16. A computing system comprising:
one or more processors; and
memory containing instructions that, when executed by the one or more processors, cause the computing system to perform operations according to the method of claim 1.
